(19) United States
(12) Patent Application Publication
(10) Pub. No.: US 2022/0213821 A1
(43) Pub. Date: Jul. 7, 2022

(54) CLOSING PLUG AND OIL DIPSTICK INCLUDING A LOCKING MECHANISM USING FIXING PROJECTIONS

(71) Applicant: DEUTZ Aktiengesellschaft, Koeln (DE)

(72) Inventors: Johannes KLOSTERBERG, Swisttal (DE); Thomas WERNER, Koeln (DE)

(21) Appl. No.: 17/613,459

(22) PCT Filed: Apr. 14, 2020
(86) PCT No.: PCT/EP2020/000084

§ 371 Date: Nov. 22, 2021

(30) Foreign Application Priority Data
May 31, 2019 (DE) 102019003809.6

(51) Int. Cl. F01M 11/12

(52) U.S. Cl. CPC F01M 11/12

(57) ABSTRACT

An internal combustion engine is described, in particular a diesel internal combustion engine, including a crankcase (5), in which a crankshaft is rotatably mounted, to which a connecting rod supporting a piston is linked, the piston being movable in a cylinder, which is covered by a cylinder head, forming a combustion chamber, and gas exchange valves being situated in the cylinder head, which are actuated by a camshaft, fuel conveyed by an injection pump element being furthermore injected into the combustion chamber, and including a closing plug (1).

The present disclosure relates to an internal combustion engine, including a crankcase, in which a crankshaft is rotatably mounted, to which a connecting rod supporting a piston is linked, the piston being movable in a cylinder, which is covered by a cylinder head, forming a combustion chamber, and gas exchange valves being situated in the cylinder head, which are actuated by a camshaft, which is connected via a gearing to a wheel drive pinion situated on the crankshaft, fuel conveyed by an injection pump element being furthermore injectable into the combustion chamber, and including a closing plug and an oil dipstick including a locking mechanism using fixing projections.

### BACKGROUND

Elements for closing a bore in the general sense are known in many ways.

If one compares the produced designs, they may be divided into four essential classes (design principles):

a. Closure with the aid of a screw plug.
b. Closure with the aid of a pressed-in cover or plug.
c. Closure by a screwed-on cover.
d. Closure by a plug fixed in a form-fitting manner.

If the closure is also to provide a seal against a medium, this may take place in the following ways:

a.) By a sealing ring, which is pressed upon tightening a screw plug.
b.) By sealing means at a thread of a screw plug.
c.) By pressing a cover or a plug against the bore wall. A sealing means is often additionally used.
d.) By a sealing cover, using an O ring, sealing paper or a sheet crimp seal. The fastening of the cover takes place via separate threaded bores near the bore to be closed.

### SUMMARY

All three principles mentioned have disadvantages for the application or objective considered here of “closing an oil dipstick bore.” The requirement of removability and possibly even reusability is essential. In addition, the bore surface should not be damaged. It should be possible, for example, to remove the closing plug on the left side of the engine, to install the oil dipstick on the right side of the engine at this location and to close the now open opening on the right side of the engine with the aid of the previously removed plug. If one of the aforementioned design principles is used for the closure, this means that:

a: It is not possible to introduce an inner thread for a screw plug since the O ring of the oil dipstick would come into contact with the threaded area. The dipstick would therefore have to be adapted. It would also be necessary to apply material to the oil dipstick plug at the crankcase (=> tool change). The additional thread in the bore would further increase the processing costs of the crankcase.
b: A pressed-in sealing cover or plug would be difficult to remove and would probably be destroyed. The sealing surface would also be damaged during the removal of the plug.
c: A screwed-on cover would mean an additional fastening thread at the crankcase and thus result in a tool adaptation and increased processing costs at the crankcase.
d: The introduction of a groove or the like, with which a projection engages at the closing plug, would be expensive to introduce at the crankcase.

The disadvantage of this is that the described variants are expensive and bulky.

It is an object of the present disclosure to provide an internal combustion engine, which is reliably tight and reusable at reasonable cost.

This object is achieved in that the new approach uses the principle of the form fit. However, no change or added expense of the crankcase is necessary. The approach is non-destructively removable and does not result in damage to the O ring sealing surface for the oil dipstick. The approach may also be reused.

### BRIEF DESCRIPTION OF THE DRAWINGS

Further advantageous embodiments of the present disclosure are apparent from the description of the drawing, in which an exemplary embodiment illustrated in the figures is described in greater detail.

FIG. 1 shows a closing plug, mounted in the crankcase;

FIG. 2 shows a closing plug, including centering projections;

FIG. 3 shows an oil dipstick fixed by centering projections in the crankcase.

### DETAILED DESCRIPTION

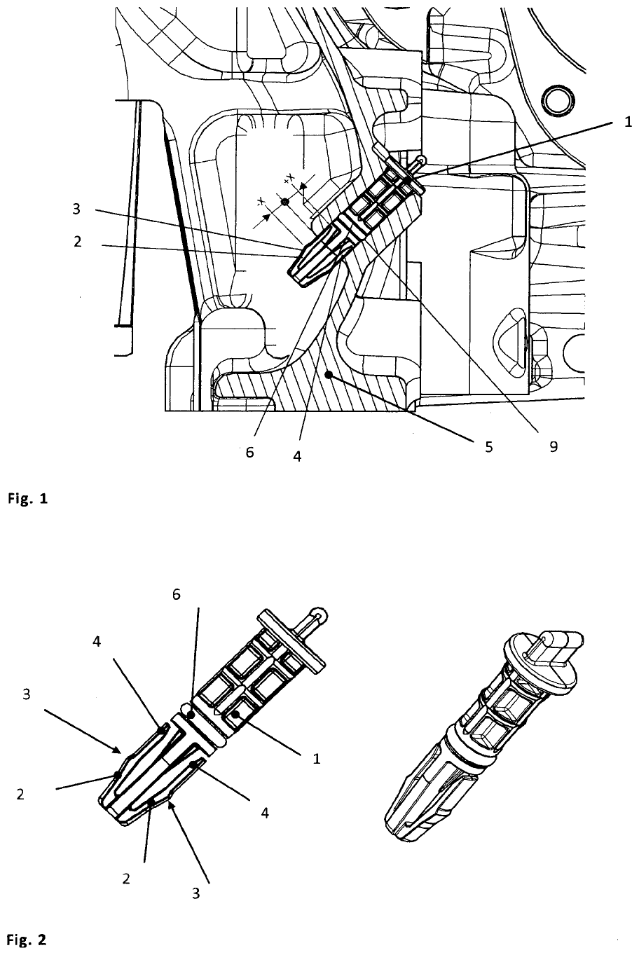

FIG. 1 shows a closing plug 1, mounted in a closing plug channel 9, closing plug channel 9 being situated in a crankcase 5. An O ring 6 situated on closing plug 1 is used to seal closing plug channel 9. Centering projections 2, thickening 3 and end piece 4 are situated on closing plug 1 below O ring 6 in the direction of the interior of crankcase 5.

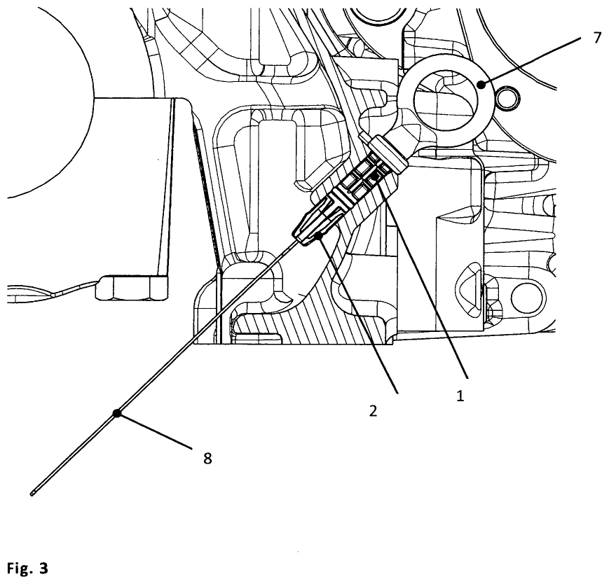

A closing plug 1, including centering projections 2, is described in FIG. 2, which includes an O ring 6 and in which thickening 3 and end piece 4 are situated below O ring 6 in the direction of centering projections 2.

The special feature of the new approach involves two fixing projections 2 at the end of plug 1, as is apparent in FIGS. 1 through 3. Upon inserting plug 1 into the bore or also into closing plug channel 9 of crankcase 5, projections 2 are first pressed together, the projections then spread apart again shortly before reaching the end installation position, as is apparent in FIGS. 1 and 3. Thickening 3 at projections 2 locks plug 1 against a force-free removal. Due to the stiffness of projections 2, which may be structurally influenced, as well as the geometry of thickening 3, the force needed for installation may be set. The thickening at the projection is furthermore positioned in such a way that, on the one hand, upon a negative cast mismatch (−x), the thickening does not remain in the bore, as is also apparent in FIG. 1. Otherwise, a jamming effect would not occur. On the other hand, upon a positive cast mismatch (+x), end piece 4 of the projection may not emerge entirely from the bore wall. The end piece of the projections would otherwise become wedged behind the bore and no longer permit a destruction-free removal of plug 1.

Plug 1 receives an O ring 6 for the purpose of sealing.

Moreover, the fastening principle described in this manner is transferable to an oil dipstick 8, as described in FIG. 3. The latter is made up of plug body 1, to which gripping area 7 and oil dipstick 8 are added. FIG. 3 shows a closing plug 1, mounted in a closing plug channel 9, closing plug channel 9 being situated in a crankcase 5. An O ring 6 situated on closing plug 1 is used to seal closing plug channel 9. Centering projections 2, thickening 3 and end piece 4 are situated on closing plug 1 below O ring 6 in the direction of the interior of crankcase 5.

### LIST OF REFERENCE NUMERALS

1 closing plug
2 centering projections
3 thickening
4 end piece
5 crankcase
6 O ring
7 gripping area
8 oil dipstick
9 closing plug channel

What is claimed is:

1-8. (canceled)

9: An internal combustion engine comprising:
a crankcase;
a crankshaft rotatably mounted in the crankcase;
a connecting rod linked to the crankshaft;
a piston, the connecting rod supporting the piston
a cylinder, the piston being movable in the cylinder, the cylinder forming a combustion chamber;
a cylinder head covering the cylinder,
gas exchange valves situated in the cylinder head;
a camshaft for actuating the gas exchange valves, fuel conveyed by an injection pump element being injected into the combustion chamber; and
a closing plug.

10: The internal combustion engine as recited in claim 9, further comprising an oil dipstick.

11: The internal combustion engine as recited in claim 10, wherein the oil dipstick and the closing plug form an assembly.

12: The internal combustion engine as recited in claim 9, wherein the closing plug is provided with a locking mechanism using centering projections.

13: The internal combustion engine as recited in claim 12, wherein the closing plug includes an O ring.

14: The internal combustion engine as recited in claim 13, wherein the closing plug includes a thickening and an end piece, the O ring being situated at the closing plug above the centering projections, the thickening and the end piece.

15: The internal combustion engine as recited in claim 9, wherein the closing plug includes a thickening projecting by a measure into an interior of the crankcase in a mounted state.

16: The internal combustion engine as recited in claim 9, wherein the closing plug includes an end piece projecting into an interior of a closing plug channel of the crankcase by a measure in the mounted state.

17: An internal combustion engine comprising:
a crankcase including a channel; and
a closing plug, the closing plug including two centering projections for connecting the closing plug inside the channel via a form fit, the centering projections configured to be first pressed together and then to spread apart during while installing the closing plug in the channel.

18: The internal combustion engine as recited in claim 17, wherein the centering projections each include a respective thickening configured for locking the closing plug in the channel against a force-free removal.

19: The internal combustion engine as recited in claim 18, wherein the closing plug further includes an O ring for sealing against a surface of the channel, the centering projections being below the O ring when the closing plug is installed in the channel.

20: The internal combustion engine as recited in claim 19, wherein the centering projections each include a respective end piece, each end piece being between the respective thickening and the O ring.

21: The internal combustion engine as recited in claim 18, wherein the channel is defined by a bore wall and the closing plug is configured such that the thickening of each of the centering projections is positioned outside of the bore wall when the closing plug is connected inside the channel via the form fit.

22: The internal combustion engine as recited in claim 21, wherein the centering projections each include a respective end piece and the closing plug is configured such that the end piece of each of the centering projections is positioned at least partially inside of the bore wall when the closing plug is connected inside the channel via the form fit.

23: The internal combustion engine as recited in claim 17, further comprising a dip stick extending from an end of the closing plug.

24: A method of installing a closing plug into a channel in an internal combustion engine comprising:
inserting the closing plug into the channel such that center projections of the closing plug are first pressed together by a bore wall of the channel and then spread apart to connect the closing plug inside the channel via a form fit.

25: The method as recited in claim 24, wherein the centering projections each include a respective thickening configured for locking the closing plug in the channel against a force-free removal, the closing plug being inserted such that the thickenings do not remain the bore wall.

26: The method as recited in claim 25, wherein the closing plug further includes an O ring for sealing against a surface of the channel and the centering projections each include a respective end piece,
the closing plug being inserted such that, when the closing plug is connected inside the channel via the form fit, the end piece of each of the centering projections is positioned at least partially inside of the bore wall and the O ring is inside the bore wall.
